(19) United States
(12) Patent Application Publication
(10) Pub. No.: US 2015/0145277 A1
(43) Pub. Date: May 28, 2015

(54) TONNEAU COVER LATCHING SYSTEM

(71) Applicant: SUNWOOD INDUSTRIES CO., LTD., Changzhou (CN)

(72) Inventors: Hang Shi, Changzhou City (CN); Hongjuan Zheng, Changzhou City (CN)

(21) Appl. No.: 14/551,661

(22) Filed: Nov. 24, 2014

Related U.S. Application Data
(60) Provisional application No. 61/907,538, filed on Nov. 22, 2013.

(51) Int. Cl. B60J 7/10

(52) U.S. Cl. CPC B60J 7/104
USPC 296/100.02

(57) ABSTRACT

A tonneau cover system for a pickup truck cargo bed incorporates an internal frame work having a spring loaded latch assembly used for the ease of opening or closing of a tonneau cover system.

### FIELD OF THE INVENTION

In general the present invention relates to a pickup truck cargo bed cover and more in particularly to a bed covering system having an integrated frame work in which incorporates a spring loaded latching mechanism used for the opening or closing of the bed cover system.

### BACKGROUND AND RELATED ART

Tonneau covers have been utilized for a number of years to cover and protect the interior of pickup cargo beds against dirt debris and other environmental contaminants and in some cases, to improve the aesthetic quality of the vehicle. Originally tonneau covers were designed by upholstery shops and typically made of vinyl covered fabrics or canvas. The material was often doubled over along its edges for added strength and appearance. Male snaps were then attached to the sides of the cargo box via fasteners, while female snaps were attached along the edges of the cover. Wooden bows were often used to span the cargo box and to ensure that the cover remained high enough to drain off water. Unfortunately these covers were sometimes difficult to handle, often led to corrosion around the snaps and occasionally failed to protect the cargo box.

Over the years a wide variety of covers designs have been developed, in general these covers are known as “tonneau covers.” Tonneau cover typically lies substantially flush with the top walls of the cargo bed without significantly increasing the height of the cargo bed.

Most tonneau cover systems today are constructed of a solid or fabric material and employ an internal support frame work which installs to the cargo bed as a one piece system. Occasionally these systems are hinged to provide one or more opening section or in other designs, the cover can be disconnected from the frame work and rolled up or in other cases, they can be hinged to the cargo bed and open as a one piece solid cover. Thus in all cases these designs provide access to the cargo bed.

Clamping methods are often employed as part of the internal support frame to allow quick access to the cargo bed or when on occasion, it may be necessary to carry a load that exceeds the height limitations of the cover system and where clamping methods allow quick removal of the entire cover system from the cargo bed.

In using clamps as a locking system, a user typically would be required to uncouple at least two clamps in order to gain access to the cargo bed. The present invention only requires the user to depress or a single spring loaded lever in order to activate the unlatching of the cover section from the internal frame work.

In response to some of the aforementioned challenges, methods and systems used in the accessing of a cargo bed covered by a cover system will be addressed by the field of the present invention. These and other features and advantages may be Incorporated into certain embodiments of the invention and will become more fully apparent from the following description and appended claims, or may be learned by the practice of the invention as set forth hereinafter. The present invention does not require that all the advantageous features and all the advantages described herein be incorporated into every embodiment of the invention.

### SUMMARY OF THE INVENTION

A primarily object of the present invention is to provide ease of access to a pickup cargo bed in which is covered by a protective cover system. The cover system incorporates an internal frame work in which provides strength and stability to the system and is further used to fasten the cover system to the cargo bed.

Convention means to access the cargo bed is typically via a damp system and where at least two clamps have to be released prior to opening the cover system.

The present invention allows sectional removal structuring of the internal frame work to allow at least one end of the frame section to be removed from the main frame structure by a latching method. This removal section is permanently attached to an end section of the surface covering and when latched in place, provides a complete covering of the cargo bed.

Internal side lateral frames provide incorporated hollowed elliptical receivers to accept a longitudinal elliptical surface incorporated as part of an end frame section. When interfaced together, the end frame section is allows upward movement while still being connected to the lateral frame sections.

The end frame section further provides a secondary hollowed space in which is configured to accept a spring loaded push lever used for activating lock and release of the end section from the lateral frame sections. When the lever is depressed, the lever now provides enough clearance to allow release from the secondary hollowed space and where with upward movement, the end frame section detaches from both lateral frames.

With the release of the end frame section the mated covering surface is allowed to be lifted in order to expose the cargo bed for stowing or unloading of cargo.

The structure and the technical means adopted by the present invention is to achieve the above and other objects in which can be best understood by referring to the following detailed description of the preferred embodiments and by the accompanying drawings.

### BRIEF DESCRIPTION OF THE DRAWINGS

FIG. 1 illustrates an internal frame work and a protective covering system for a pickup truck cargo bed.

FIG. 2 illustrates a side view of the detachable end frame section incorporating the latch system.

FIG. 3 provides a secondary angled view of the latching system.

### DETAILED DESCRIPTION OF THE PREFERRED EMBODIMENTS

Tonneau covers have been utilized for a number of years to cover and protect the interior of pickup cargo beds against dirt, debris and other environmental contaminants. Most tonneau cover systems today are constructed of a solid or fabric material in which deploys an internal support frame work which provides installation provisions to the cargo bed as a one piece system. Occasionally these systems are hinged to provide one or more opening section or in other designs, the cover can be disconnected from the frame work and rolled up or they can be hinged to the cargo bed and open as a one piece solid cover. Exposure to the cargo bed is provided for by a series of clamps in which primarily are used to secure closure locking during roadway travel.

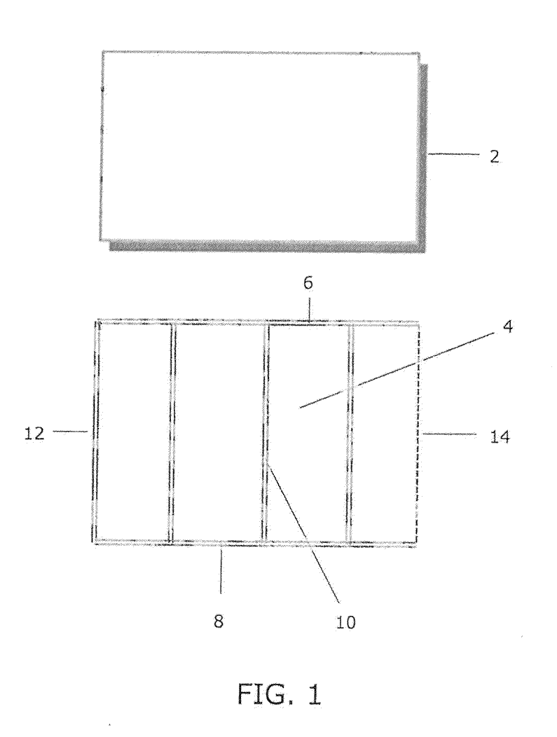

FIG. 1 illustrates a typical sub frame structure 4 used to support a surface covering 2, constructed of a foldable or collapsible fabric material. Inter sub frame components typically consisting of a series of rails, 6, 8, 10, 12, 14 constructed of a light weight metal such as aluminum. The sub structure internal frame 4 is further used to fasten the cover system to the cargo bed.

Internal side lateral frames 6 and 8 provide for the incorporation of longitudinal supports, 10, 12 and 14 and where when interfaced together form a permanent structure in which provides strength and stability to the sub frame and also to the surface covering.

Internal lateral frames are constructed as fixed components of the longitudinal frame sections in which does not permit removal of any sub frame components but whereas, all sub frame components allow the surface covering to be open or removed fur cargo bay for access.

FIG. 1 illustrates sub frame component 14 as removable from lateral frame sections 6 and 8 and where frame component 14 is permanently attached to one end of a fabric surface covering.

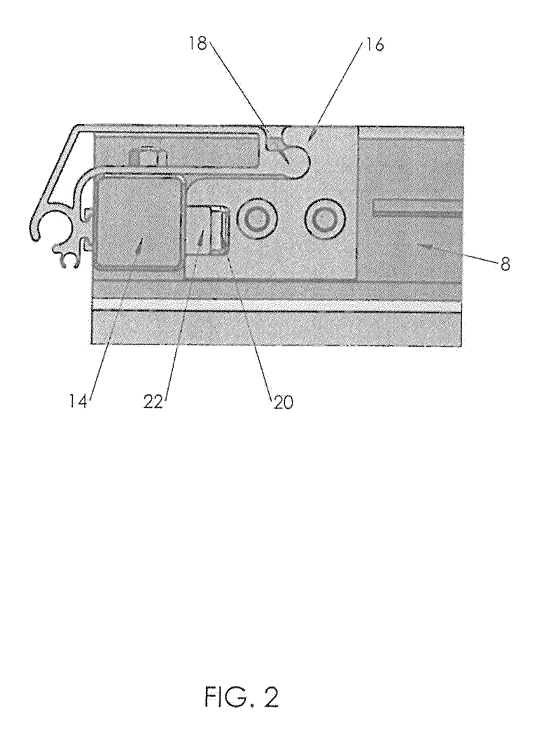

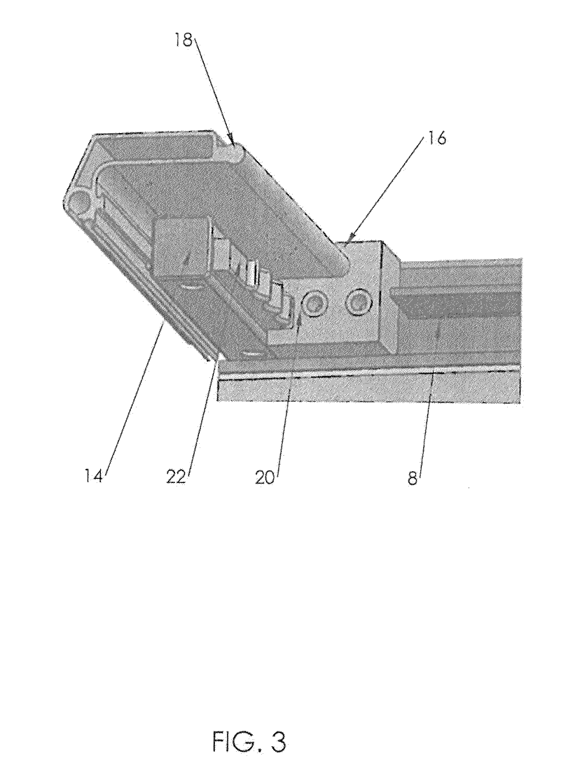

Now in reference to FIGS. 2 and 3, sub frame component 14 is constructed to provide a method for separating the surface cover from the internal lateral frames 6 and 8 via a latch mechanism 22. The latch mechanism is reliant upon the incorporation of a semi elliptical receiver 16 incorporated within lateral frame components 6 and 8. In turn sub frame component 14 provides an elliptical insert 18 in which when interfaced, allows upward movement to sub frame component 14.

Sub frame component 14 further provides a secondary hollowed space 20 in which is configured to accept a spring loaded push lever 22 used for activating lock or release of the sub frame component 14 from the lateral frame sections 6 and 8. When the lever is depressed, the lever now provides enough clearance to allow release from the secondary hollowed space and where with upward movement, the sub frame component 14 detaches from both 6 and 8 lateral frames.

The above description reveals that it is obvious that the invention can be varied in many ways. Such variations are not to be considered a deviation from the scope of the invention, and all such modifications which are obvious to persons skilled in the art are also to be considered comprised by the scope of the succeeding claims.

What is to be claimed:

1. A vehicle cargo bed comprised of side and end walls accepts and supports a protective fabric covering system comprising of an internal support frame spanned by a fabric cover.

2. A fabric protective cover supported by an internal frame work according to claim 1 provides a removal end component of the internal frame work in which is attached to one end of the protective covering.

3. According to claim 2 the removal end component incorporates an elliptical insert in which is received by a semi elliptical receiver incorporated as part of a left and right longitudinal frame rail, and where these longitudinal frame rails also provide a secondary hollowed area for the acceptance of a depressible spring loaded latch.

4. According to claim 3 the depressible spring loaded latch is incorporated as part of the removal end component.
